(19) United States
(12) Patent Application Publication
(10) Pub. No.: US 2012/0295037 A1
(43) Pub. Date: Nov. 22, 2012

(54) METHOD FOR MANUFACTURING ELECTRODES

(76) Inventors: Hideki HAGIWARA, Toyota-shi (JP); Junya MORI, Toyota-shi (JP)

(21) Appl. No.: 13/471,681

(22) Filed: May 15, 2012

(30) Foreign Application Priority Data
May 17, 2011 (JP) 2011-110744

(51) Int. Cl. H01M 4/04; B05D 3/06; B05D 3/00

(52) U.S. Cl. 427/542; 427/58

(57) ABSTRACT

A method for manufacturing electrodes includes applying an electrode mixture paste by coating to a first surface of an electrode current collector having the first surface and a second surface, to provide a first paste-coated member having a first surface that is a surface of the electrode mixture paste, and a second surface opposite to the first surface, and drying the electrode mixture paste deposited on the first surface of the electrode current collector. In the initial stage of drying of the electrode mixture paste, the quantity of heat applied to the second surface of the first paste-coated member is made larger than the quantity of heat applied to the first surface of the first paste-coated member.

### INCORPORATION BY REFERENCE

The disclosure of Japanese Patent Application No. 2011-110744 filed on May 17, 2011 including the specification, drawings and abstract is incorporated herein by reference in its entirety.

### BACKGROUND OF THE INVENTION

1. Field of the Invention

The invention relates to a method for manufacturing electrodes.

2. Description of Related Art

Various methods have been proposed as methods for manufacturing electrodes for batteries. For example, a method of producing an electrode sheet for a secondary battery is disclosed in Japanese Patent Application Publication No. 2000-106175 (JP 2000-106175 A).

The production method as follows is described in JP 2000-106175 A. Initially, a coating liquid (electrode mixture paste) is applied by coating to a surface (a first surface) of an electrode current collector (an aluminum foil) having the first surface and a second surface opposite to the first surface. Then, the electrode mixture paste deposited on the first surface of the electrode current collector is dried, using heater fans disposed on the opposite sides of the electrode current collector (aluminum foil). More specifically, a first paste-coated member formed by coating the first surface of the electrode current collector with the electrode mixture paste is exposed to hot air fed from a first heater fan disposed on one side of the first paste-coated member which is closer to the first surface of the electrode current collector than to the second surface, and is also exposed to hot air fed from a second heater fan disposed on the other side of the first paste-coated member which is closer to the second surface than to the first surface, so that the electrode mixture paste is dried. The temperature and quantity of hot air fed from the first heater fan are equal to those of hot air fed from the second heater fan.

However, cracks may be formed on an electrode mixture layer formed by drying the electrode mixture paste, if the electrode mixture paste is dried by exposing the first paste-coated member formed by coating the first surface of the electrode current collector with the electrode mixture paste, to hot air fed from the first heater fan disposed on the above-indicated one side of the first paste-coated member, and also exposing the first paste-coated member to hot air fed from the second heater fan disposed on the other side, while controlling the temperature and quantity of hot air fed from the first heater fan to be equal to those of hot air fed from the second heater fan, as in JP 2000-106175.

### SUMMARY OF THE INVENTION

A study conducted by the inventor of the present invention revealed that, when the electrode mixture paste is dried in the manner as disclosed in JP 2000-106175 A, a surface of the electrode mixture paste tends to be dried at an early stage, in a condition where a large amount of solvent remains in an inner portion (adjacent to the electrode current collector) of the electrode mixture paste. Therefore, it is presumed that contraction stress is applied to a thin film on the surface (a film formed when the surface of the electrode mixture paste is dried), and cracks are formed because the contraction stress exceeds the strength of the thin film on the surface.

The invention provides a method for manufacturing electrodes, which makes it unlikely or less likely to form cracks in an electrode mixture layer formed by drying an electrode mixture paste.

One aspect of the invention is concerned with a method for manufacturing electrodes, which includes applying an electrode mixture paste by coating to a first surface of an electrode current collector having the first surface and a second surface, to provide a first paste-coated member in which the electrode mixture paste is deposited on the first surface of the electrode current collector, the first paste-coated member having a first surface comprising a surface of the electrode mixture paste, and a second surface opposite to the first surface of the first paste-coated member, and drying the electrode mixture paste deposited on the first surface of the electrode current collector. In an initial stage of drying of the electrode mixture paste, the electrode mixture paste is dried such that the quantity of heat applied to the second surface of the first paste-coated member is made larger than a quantity of heat applied to the first surface of the first paste-coated member.

In the manufacturing method as described above, in the initial stage of drying, the electrode mixture paste is dried such that the quantity of heat applied to the second surface of the first paste-coated member is made larger than the quantity of heat applied to the first surface of the first paste-coated member. Namely, in the initial stage of drying of the electrode mixture paste deposited on the first surface of the electrode current collector, the electrode mixture paste is dried such that the quantity of heat applied to the second surface of the electrode current collector on which the electrode mixture paste is not deposited is made larger than the quantity of heat applied to the surface of the electrode mixture paste deposited on the first surface of the electrode current collector. In this manner, the inner portion (adjacent to the electrode current collector) of the electrode mixture paste can be dried earlier, or in a shorter time. Consequently, cracks are prevented from being formed or less likely to be formed in an electrode mixture layer formed by drying the electrode mixture paste.

If an electrode having an electrode mixture layer in which cracks are formed is used in a battery, nonuniform reactions may occur in the electrode, and battery characteristics may deteriorate. Accordingly, it is undesirable that cracks are formed in the electrode mixture layer formed by drying the electrode mixture paste. The electrode mixture paste is an electrode mixture containing a solvent, which may be obtained by mixing an active material and a binder in the solvent.

In the initial stage of drying, the second surface of the first paste-coated member may be exposed to hot air.

By exposing the second surface of the first paste-coated member (formed by coating the first surface of the electrode current collector with the electrode mixture paste) to hot air (without exposing the first surface of the first paste-coated member to hot air) in the initial stage of drying, the electrode mixture paste can be dried such that the quantity of heat applied to the second surface of the first paste-coated member is made larger than the quantity of heat applied to the first surface of the first paste-coated member. Thus, cracks are prevented from being formed or less likely to be formed in the electrode mixture layer.

Alternatively, in the initial stage of drying, the second surface of the first paste-coated member may be irradiated with infrared rays.

By irradiating the second surface of the first paste-coated member (formed by coating the first surface of the electrode current collector with the electrode mixture paste) with infrared rays (without irradiating the first surface of the first paste-coated member with infrared rays) in the initial stage of drying, the electrode mixture paste can be dried such that the quantity of heat applied to the second surface of the first paste-coated member is made larger than the quantity of heat applied to the first surface of the first paste-coated member. Thus, cracks are prevented from being formed or less likely to be formed in the electrode mixture layer.

In the manufacturing method as described above, the basis weight of the electrode mixture paste deposited on the first surface of the electrode current collector may be controlled to be equal to or larger than 10 mg/cm², and the drying time for which the electrode mixture paste is dried may be set to a period of time that satisfies a relationship that the basis weight (mg/cm²)/the drying time (sec.)≧0.3.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of a drying device according to one embodiment of the invention;

FIG. 2 is a graph indicating the air velocity of air fed from each fan of the drying device of FIG. 1;

FIG. 3 is a flowchart of a process of producing a positive electrode sheet, which is useful for explaining a method for manufacturing electrodes according to the embodiment of the invention;

FIG. 4 is a view useful for explaining a first coating step;

FIG. 5 is a view useful for explaining a first drying step;

FIG. 6 is a view useful for explaining a second coating step;

FIG. 7 is a view useful for explaining a second drying step;

FIG. 8 is a view useful for explaining a compression molding step;

FIG. 9 is a schematic view of a drying device according to a modified example of the embodiment of the invention;

FIG. 10 is a schematic view of a drying device according to a comparative example; and

FIG. 11 is a graph showing results of a drying test concerning the comparative example.

### DETAILED DESCRIPTION OF EMBODIMENTS

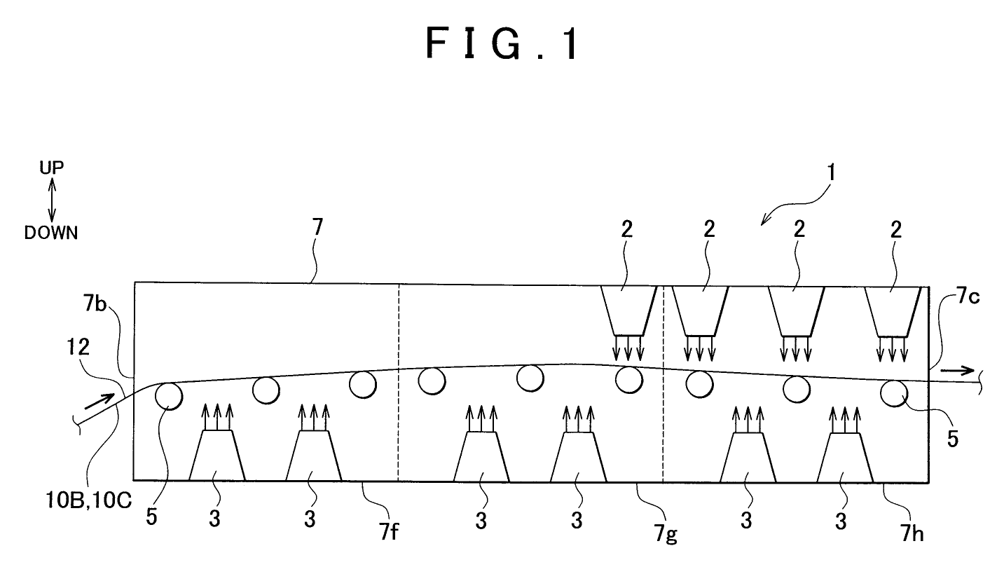

One embodiment of the invention will be described. FIG. 1 is a schematic view of a drying device 1 according to the embodiment. The drying device 1 is used for drying a positive electrode mixture paste 12 applied by coating to a first surface 11b (or a second surface 11c) of a positive electrode current collector 11. More specifically, the drying device 1 includes a drying furnace 7, a plurality of upper fans 2 disposed in an upper section of the drying furnace 7, a plurality of lower fans 3 disposed in a lower section of the drying furnace 7, and a plurality of rollers 5 disposed in a middle section of the drying furnace 7, as shown in FIG. 1.

The above-indicated plurality of rollers 5 are arranged at certain intervals in the longitudinal direction of the drying furnace 7 (the lateral direction in FIG. 1) over the entire length thereof, and are operable to feed a first paste-coated member 10B formed by coating the first surface 11b of the positive electrode current collector 11 with the positive electrode mixture paste 12, from an inlet 7a of the drying furnace 7 toward an outlet 7c thereof. The rollers 5 are also operable to feed a second paste-coated member 10C formed by coating the second surface 11c of the positive electrode current collector 11 with the positive electrode mixture paste 12, from the inlet 7b of the drying furnace 7 toward the outlet 7b.

In this embodiment, in a first drying step, the first paste-coated member 10B moves in the drying furnace 7 from the inlet 7b of the furnace 7 toward the outlet 7c, such that the first surface 11b coated with the positive electrode mixture paste 12 faces upward, and the second surface 11c faces downward. Also, in a second drying step, the second paste-coated member 10C moves in the drying furnace 7 from the inlet 7b of the furnace 7 toward the outlet 7c, such that the second surface 11c coated with the positive electrode mixture paste 12 faces upward, and the first surface 11b faces downward.

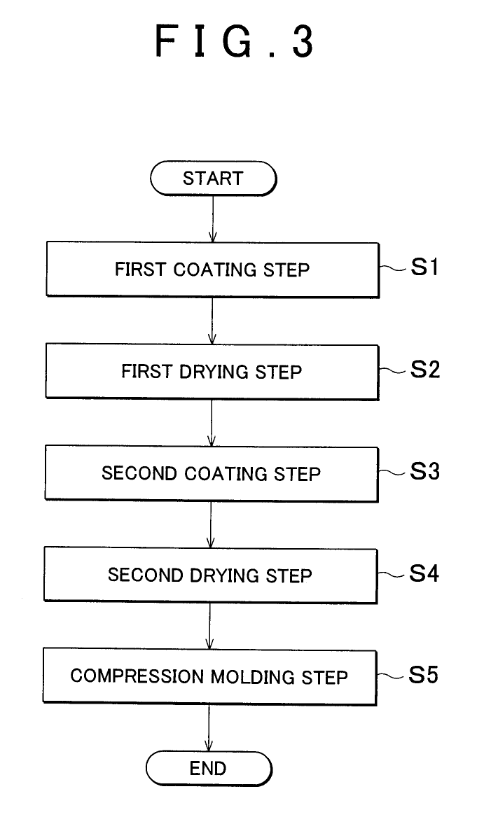

The upper fans 2 serve to blow hot air downward in the drying furnace 7. In the first drying step, the upper fans 2 feed hot air to the first paste-coated member 10B that moves in the drying furnace 7, such that the upper surface of the first paste-coated member 10B as viewed in FIG. 1 (i.e., a surface 12b (see FIG. 3) of the positive electrode mixture paste 12) is exposed to the hot air. In the second drying step, the upper fans 2 feeds hot air to the second paste-coated member 10C that moves in the drying furnace 7, such that the upper surface of the second paste-coated member 10C as viewed in FIG. 1 (i.e., a surface 12b of the positive electrode mixture paste 12) is exposed to the hot air.

The lower fans 3 serve to blow hot air upward in the drying furnace 7. In the first drying step, the lower fans 3 feed hot air to the first paste-coated member 10B that moves in the drying furnace 7, such that the lower surface of the first paste-coated member 10B as viewed in FIG. 1 (i.e., the second surface 11c of the positive electrode current collector 11) is exposed to the hot air. In the second drying step, the lower fans 3 feed hot air to the second paste-coated member 10C that moves in the drying furnace 7, such that the lower surface of the second paste-coated member 10C as viewed in FIG. 1 (i.e., a surface 13b (see FIG. 6) of an electrode mixture layer 13) is exposed to the hot air.

In the drying device 1 of this embodiment, a total of six lower fans 3 are arranged over the length of the drying furnace 7 from the inlet 7b to the outlet 7c. More specifically, when the interior of the drying furnace 7 is divided into three zones (a first zone 7f, a second zone 7g, and a third zone 7h) arranged in a direction from the inlet 7b to the outlet 7c, the lower fans 3 are positioned such that two of the fans 3 are contained in each zone while being spaced from each other.

With the above arrangement, in the first drying step, the lower surface of the first paste-coated member 10B as viewed in FIG. 1 (i.e., the second surface 11c of the positive electrode current collector 11) is exposed to hot air supplied from the lower fans 3, over the entire period from the initial stage of drying of the positive electrode mixture paste 12 deposited on the first surface 11b, to the end of drying. Similarly, in the second drying step, the lower surface of the second paste-coated member 10C as viewed in FIG. 1 (i.e., the surface 13b of the electrode mixture layer 13) is exposed to hot air supplied from the lower fans 3, over the entire period from the initial stage of drying of the positive electrode mixture paste 12 deposited on the second surface 11c, to the end of drying.

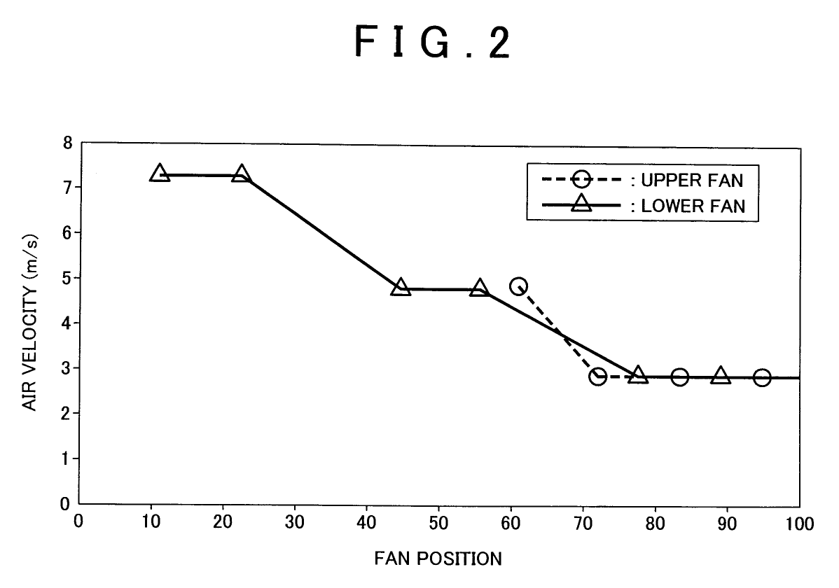

In the drying device 1 of this embodiment, the temperature of hot air fed from the lower fans 3 is set to 150° C. Also, the air velocity of hot air fed from the lower fans 3 is set as indicated in FIG. 2. More specifically, the air velocity of hot air fed from the lower fans 3 located in the first zone 7f is set to 7 m/sec. The air velocity of hot air fed from the lower fans 3 located in the second zone 7g is set to 5 m/sec. Also, the air velocity of hot air fed from the lower fans 3 located in the third zone 7h is set to 3 m/sec. In FIG. 2, the locations of the respective fans are represented by numerical values where the overall length of the drying furnace 7 is denoted as 100. Namely, the locations of the fans are indicated in FIG. 2 while the location of the inlet 7b of the drying furnace 7 is denoted as 0, and the location of the outlet 7c is denoted as 100.

On the other hand, a total of four upper fans 2 are disposed in the drying furnace 7. More specifically, none of the upper fans 2 is disposed in the first zone 7f, and one of the upper fans 2 is disposed in the second zone 7g at a location closer to the outlet 7c, while the remaining three upper fans 2 are disposed in the third zone 7h at given intervals. With this arrangement, in the first drying step of this embodiment, the upper surface of the first paste-coated member 10B as viewed in FIG. 1 is not exposed to hot air fed from the upper fans 2, in the initial stage of drying of the positive electrode mixture paste 12 deposited on the first surface 11b.

More specifically, in the first drying step, the upper surface of the first paste-coated member 10B as viewed in FIG. 1 is exposed to hot air fed from the upper fans 2, only during the middle and subsequent periods of drying of the positive electrode mixture paste 12 deposited on the first surface 11b. Similarly, in the second drying step, the upper surface of the second paste-coated member 10C as viewed in FIG. 1 is not exposed to hot air in the initial stage of drying of the positive electrode mixture paste 12 deposited on the second surface 11c, but is exposed to hot air only during the middle and subsequent periods of drying of the positive electrode mixture paste 12.

Thus, in this embodiment, in the initial stage of the first drying step, hot air is applied to the first paste-coated member 10B formed by coating the first surface 11b of the positive electrode current collector 11 with the positive electrode mixture paste 12, such that the upper surface of the first paste-coated member 10B (i.e., the surface 12b of the positive electrode mixture paste 12) is not exposed to hot air, but the lower surface of the first paste-coated member 10B is exposed to hot air. Also, in the initial stage of the second drying step, hot air is applied to the second paste-coated member 10C formed by coating the second surface 11c of the positive electrode current collector 11 with the positive electrode mixture paste 12, such that the upper surface of the second paste-coated member 10C (i.e., the surface 12b of the positive electrode mixture paste 12) is not exposed to hot air, but the lower surface of the second paste-coated member 10C is exposed to hot air.

Thus, in this embodiment, in the initial stage of the first drying step, the quantity of heat applied to the lower surface of the first paste-coated member 10B formed by coating the first surface 11b of the positive electrode current collector 11 with the positive electrode mixture paste 12 is made larger than the quantity of heat applied to the upper surface of the first paste-coated member 10B, so that the positive electrode mixture paste 12 can be dried. Namely, in the initial stage of drying of the positive electrode mixture paste 12 deposited on the first surface 11b, the quantity of heat applied to the second surface 11c on which the positive electrode mixture paste 12 is not deposited is made larger than the quantity of heat applied to the surface 12b of the positive electrode mixture paste 12 deposited on the first surface 11b, so that the positive electrode mixture paste 12 can be dried. As a result, in the first drying step, an inner portion (adjacent to the positive electrode current collector 11) of the positive electrode mixture paste 12 deposited on the first surface 11b can be dried earlier, i.e., in a shorter time. Consequently, cracks are prevented from being formed or less likely to be formed in an electrode mixture layer 13 formed by drying the positive electrode mixture paste 12.

Also, in the initial stage of the second drying step, the quantity of heat applied to the lower surface of the second paste-coated member 10C formed by coating the second surface 11c of the positive electrode current collector 11 with the positive electrode mixture paste 12 is made larger than the quantity of heat applied to the upper surface of the second paste-coated member 10C, so that the positive electrode mixture paste 12 can be dried. Namely, in the initial stage of the positive electrode mixture paste 12 deposited on the second surface 11c, the quantity of heat applied to the surface 13b of the electrode mixture layer 13 formed on the first surface 11b of the positive electrode current collector 11 is made larger than the quantity of heat applied to the surface 12b of the positive electrode mixture paste 12 deposited on the second surface 11c, so that the positive electrode mixture paste 12 can be dried. As a result, in the second drying step, an inner portion (adjacent to the positive electrode current collector 11) of the positive electrode mixture paste 12 deposited on the second surface 11c can be dried earlier, i.e., in a shorter time. Consequently, cracks are prevented from being formed or less likely to be formed in the electrode mixture layer 13 formed by drying the positive electrode mixture paste 12.

In the drying device 1 of this embodiment, the temperature of hot air fed from the upper fans 2 is set to 150° C. Also, the air velocity of hot air fed from the upper fans 2 is set as indicated in FIG. 2. More specifically, the air velocity of hot air fed from the upper fan 2 located in the second zone 7g is set to 5 m/sec. Also, the air velocity of hot air fed from the upper fans 2 located in the third zone 7h is set to 3 m/sec.

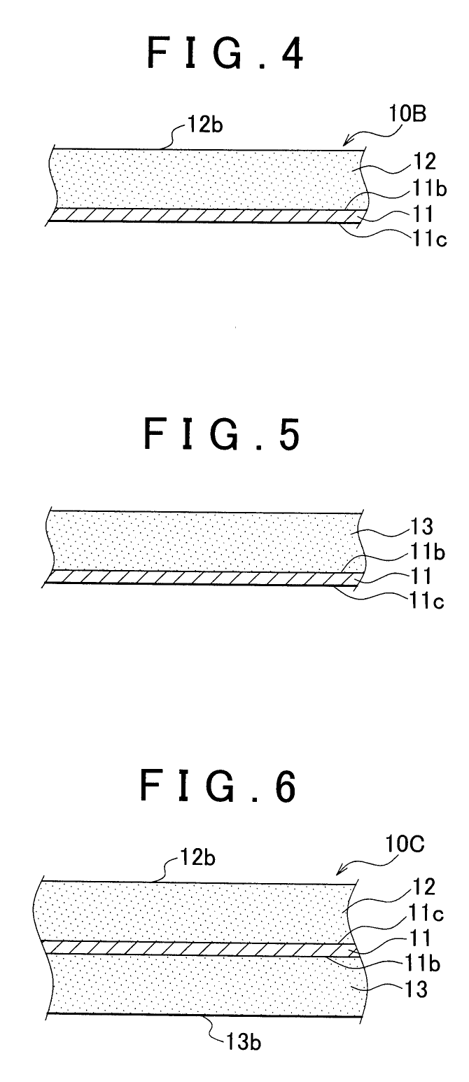

Next, a method for manufacturing electrodes according to one embodiment of the invention will be described. FIG. 3 is a flowchart of a process of producing a positive electrode sheet 10, which is useful for explaining the method for manufacturing electrodes according to the embodiment. Initially, in step S1 (a first coating step), the positive electrode mixture paste 12 is applied by coating to the first surface 11b of the positive electrode current collector 11 having the first surface 11b and the second surface 11c (see FIG. 4). More specifically, the positive electrode mixture paste 12 is applied by coating to the first surface 11b of the positive electrode current collector 11 fed at a constant speed, using a coating device (not shown), so as to fabricate the first paste-coated member 10B (see FIG. 4).

In this embodiment, the basis weight of the positive electrode mixture paste 12 deposited on the first surface 11b is controlled to be equal to or larger than 10 mg/cm² (for example, 20 mg/cm²). By making the basis weight of the positive electrode mixture paste 12 as large as 10 mg/cm² or larger, it is possible to provide the positive electrode 10 with a high capacity, to thus provide a high-capacity battery.

An aluminum foil having a thickness of 15 μm is used as the positive electrode current collector 11. To provide the positive electrode mixture paste 12, a positive electrode active material (LiNi_{1/3}Co_{1/3}Mn_{1/3}O₂), an electrically conductive material (acetylene black), and a binder (PVDF) are dispersed in a positive electrode solvent (NMP), and formed into a paste. The solid content percentage of the positive electrode mixture paste 12 is 60 wt %. The mixing ratio of the positive electrode active material, the conductive material, and the binder is 91:6:3 (weight ratio).

Then, in step S2 (the first drying step), the positive electrode mixture paste 12 deposited on the first surface 11b of the positive electrode current collector 11 is dried. More specifically, the first paste-coated member 10B formed by coating the first surface 11b of the positive electrode current collector 11 with the positive electrode mixture paste 12 is fed at a constant speed, and passed through the drying furnace 7 of the drying device 1 as described above, so that the positive electrode mixture paste 12 is dried. As a result, the positive electrode solvent (NMP) is removed (evaporated) from the positive electrode mixture paste 12, and the electrode mixture layer 13 is formed on the first surface 11b of the positive electrode current collector 11.

As described above, in the initial stage of step S2 (the first drying step), the positive electrode mixture paste 12 is dried such that the quantity of heat applied to the lower surface of the first paste-coated member 10B is made larger than the quantity of heat applied to the upper surface of the first paste-coated member 10B. Namely, in the initial stage of drying, the positive electrode mixture paste 12 is dried such that the quantity of heat applied to the second surface 11c of the positive electrode current collector 11 on which the positive electrode mixture paste 12 is not deposited is made larger than the quantity of heat applied to the surface 12b of the positive electrode mixture paste 12 deposited on the first surface 11b. As a result, in the first drying step, the inner portion (adjacent to the positive electrode current collector 11) of the positive electrode mixture paste 12 deposited on the first surface 11b can be dried earlier, i.e., in a shorter time. Consequently, cracks are prevented from being formed or less likely to be formed in the electrode mixture layer 13 formed by drying the positive electrode mixture paste 12.

In this embodiment, in the first drying step, the drying time of the positive electrode mixture paste 12 is set to a period of time that satisfies a relationship that “basis weight (mg/cm²)/drying time (sec.)≧0.3”. In the case where the basis weight of the positive electrode mixture paste 12 deposited on the first surface 11b of the positive electrode current collector 11 is 20 mg/cm², for example, the drying time of the positive electrode mixture paste 12 is set to be within 66.7 seconds. More specifically, where the basis weight of the positive electrode mixture paste 12 is 20 mg/cm², the feed speed of the first paste-coated member 10B is controlled so that the time it takes the first paste-coated member 10B to reach the outlet 7c of the drying furnace 7 of the drying device 1 after passing through the inlet 7b of the furnace 7 becomes equal to or shorter than 66.7 seconds.

It is thus possible to enhance the production efficiency of the positive electrodes 10, by reducing the drying time while assuring a sufficiently large basis weight of the positive electrode mixture paste 12. In order to appropriately dry the positive electrode mixture paste 12, even though the drying time of the positive electrode mixture paste 12 is reduced to a period that satisfies the relationship that “basis weight (mg/cm²)/drying time (sec.)≧0.3”, the drying temperature (the temperature of hot air) is controlled to be as high as 150° C. in this embodiment.

In the case where the basis weight of the positive electrode mixture paste is made as large as 10 mg/cm² or larger, if the positive electrode mixture paste is dried by exposing the first paste-coated member to hot air fed from a first heater fan (upper fan) disposed on one side of the first paste-coated member, and exposing the first paste-coated member to hot air fed from a second heater fan (lower fan) disposed on the other side thereof, while controlling the temperature and quantity of hot air fed from the first heater fan (upper fan) and the second heater fan (lower fan) to equal values, as in JP 2000-106175, cracks are likely to be formed in the electrode mixture layer. In addition, if the positive electrode mixture paste is dried at a high temperature in a short time, more specifically, if it is dried at a drying temperature of around 150° C., for a period of time (drying time) that satisfies the relationship that “basis weight (mg/cm²)/drying time (sec.)≧0.3”, in particular, cracks tend to be readily formed in the electrode mixture layer.

In this embodiment, on the other hand, in the initial stage of the first drying step, the positive electrode mixture paste 12 is dried such that the quantity of heat applied to the lower surface of the first paste-coated member 10B is made larger than the quantity of heat applied to the upper surface of the first paste-coated member 10B. Namely, in the initial stage of drying, the positive electrode mixture paste 12 is dried such that the quantity of heat applied to the second surface 11c of the positive electrode current collector 11 on which the positive electrode mixture paste 12 is not deposited is made larger than the quantity of heat applied to the surface 12b of the positive electrode mixture paste 12 deposited on the first surface 11b. As a result, even if the basis weight and the drying time are set as described above, cracks are prevented from being formed or less likely to be formed in the electrode mixture layer 13 formed by drying the positive electrode mixture paste 12.

Then, in step S3 (the second coating step), the positive electrode mixture paste 12 is also applied by coating to the second surface 11c of the positive electrode current collector 11. More specifically, the positive electrode mixture paste 12 is applied by coating to the second surface 11c of the positive electrode current collector 11 on which the electrode mixture layer 13 is formed on the first surface 11b through steps S1, S2, using a coating device (not shown), so as to fabricate the second paste-coated member 10C (see FIG. 6).

In this embodiment, the basis weight of the positive electrode mixture paste 12 deposited on the second surface 11c is controlled to be equal to or larger than 10 mg/cm² (for example, 20 mg/cm²). By making the basis weight of the positive electrode mixture paste 12 as large as 10 mg/cm² or larger, it is possible to provide the positive electrode 10 with a high capacity, to thus provide a high-capacity battery.

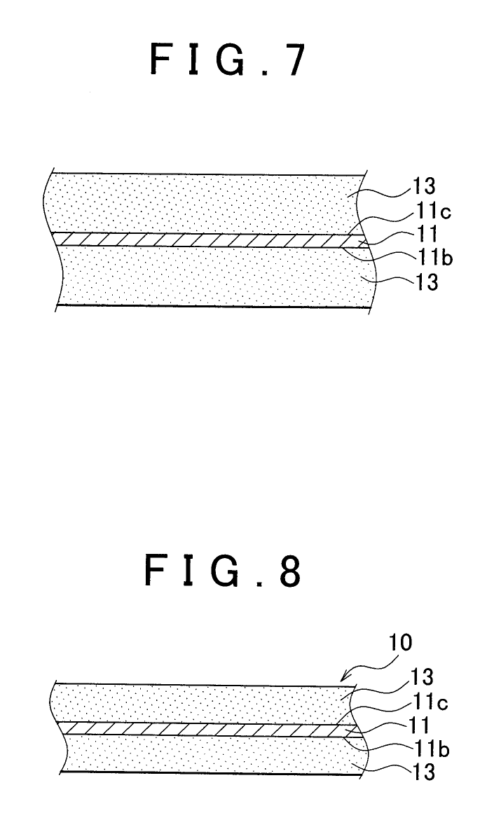

Then, in step S4 (the second drying step), the positive electrode mixture paste 12 deposited on the second surface 11b of the positive electrode current collector 11 is dried. More specifically, the second paste-coated member 10C formed by coating the second surface 11c of the positive electrode current collector 11 with the positive electrode mixture paste 12 is fed at a constant speed, and passed through the drying furnace 7 of the drying device 1 as described above, so that the positive electrode mixture paste 12 is dried. As a result, the positive electrode solvent (NMP) is removed (evaporated) from the positive electrode mixture paste 12, and the electrode mixture layer 13 is also formed on the second surface 11c of the positive electrode current collector 11 (see FIG. 7).

As described above, in the initial stage of step S4 (the second drying step), the positive electrode mixture paste 12 is dried such that the quantity of heat applied to the lower surface of the second paste-coated member 10C is made larger than the quantity of heat applied to the upper surface of the second paste-coated member 10C. Namely, in the initial stage of drying, the positive electrode mixture paste 12 is dried such that the quantity of heat applied to the surface 13b of the electrode mixture layer 13 already formed on the first surface 11b of the positive electrode current collector 11 is made larger than the quantity of heat applied to the surface 12b of the positive electrode mixture paste 12 deposited on the second surface 11c of the positive electrode current collector 11. As a result, in the second drying step, too, the inner portion (adjacent to the positive electrode current collector 11) of the positive electrode mixture paste 12 deposited on the second surface 11c can be dried earlier, or in a shorter time. Consequently, cracks are prevented from being formed or less likely to be formed in the electrode mixture layer 13 formed by drying the positive electrode mixture paste 12.

In this embodiment, in the second drying step, the drying time of the positive electrode mixture paste 12 is set to a period of time that satisfies the relationship that “basis weight (mg/cm²)/drying time (sec.)≧0.3”, as in the first drying step. In the case where the basis weight of the positive electrode mixture paste 12 deposited on the second surface 11c of the positive electrode current collector 11 is 20 mg/cm², for example, the drying time of the positive electrode mixture paste 12 is set to be within 66.7 seconds. More specifically, where the basis weight of the positive electrode mixture paste 12 is 20 mg/cm², the feed speed of the second paste-coated member 10C is controlled so that the time it takes the second paste-coated member 10C to reach the outlet 7c of the drying furnace 7 of the drying device 1 after passing through the inlet 7b of the furnace 7 becomes equal to or shorter than 66.7 seconds.

Then, in step S5 (a compression molding step), the electrode mixture layers 13 formed on the first surface 11b and second surface 11c of the positive electrode current collector 11 are subjected to compression molding, so that a positive electrode sheet 10 is completed (see FIG. 8). According to the manufacturing method as described above, cracks are prevented from being formed or less likely to be formed in the electrode mixture layers 13. The positive electrode sheet 10 thus produced may be used for forming positive electrodes of lithium-ion secondary batteries, for example.

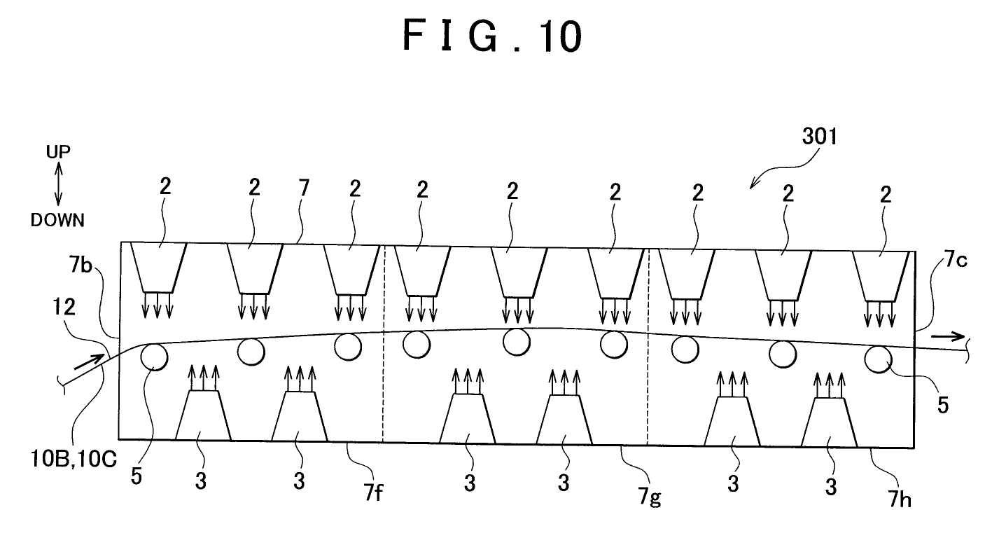

Next, a comparative example will be described. FIG. 10 is a schematic view of a drying device 301 according to the comparative example. The drying device 301 is different from the drying device 1 of the illustrated embodiment in that upper fans 2 are provided in the first zone 7f, and additional upper fans 2 are provided in the second zone 7g, and that the air velocities of hot air fed from the upper fans 2 and the lower fans 3 are all controlled to the same velocity (e.g., 3 m/sec.). The other features of the drying device 301 are identical with or similar to those of the drying device 1 of the illustrated embodiment.

In the drying device 301 of the comparative example, in the first drying step, the lower surface of the first paste-coated member 10B as viewed in FIG. 10 is exposed to hot air fed from the lower fans 3, and the upper surface of the first paste-coated member 10B as viewed in FIG. 10 is also exposed to hot air fed from the upper fans 2, over the entire period from the initial stage of drying of the positive electrode mixture paste 12 deposited on the first surface 11b of the positive electrode current collector 11, to the end of drying. The second paste-coated member 10C is also exposed to hot air in the same manner in the second drying step. The drying method as described above is similar to that as disclosed in the above-identified JP 2000-106175 A.

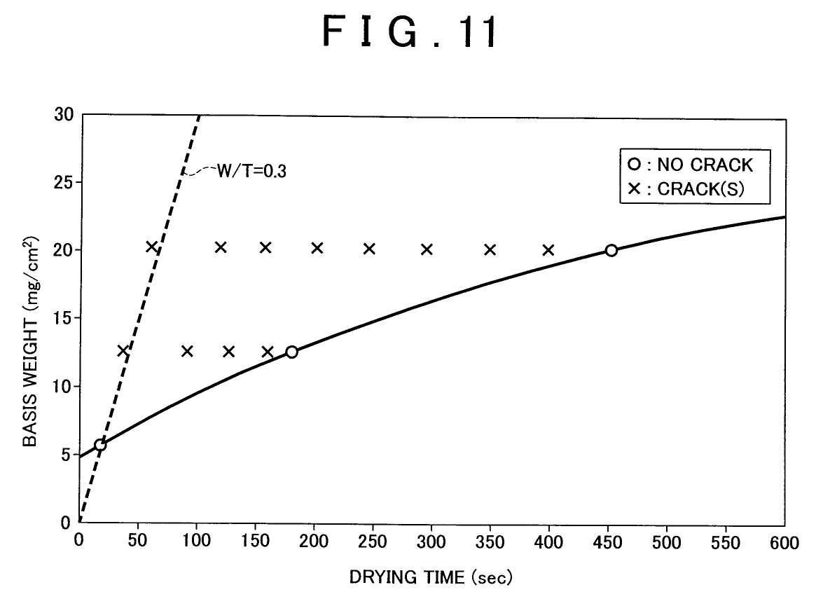

Next, results of a drying test conducted using the drying device 301 of the comparative example will be explained. In the drying test, three types of first paste-coated members having different basis weights W (mg/cm²) of the positive electrode mixture paste 12 deposited on the first surface 11b of the positive electrode current collector 11 were fabricated, wherein the basis weights W were 5.85, 12.5, and 20 (mg/cm²), respectively. For each type of first paste-coated member, the drying time T (sec.) for which the member was dried by the drying device 301 was varied, and the presence or absence of cracks in the electrode mixture layer formed by drying the positive electrode mixture paste 12 was checked. The results of the test are shown in FIG. 11. In FIG. 11, specimens in which cracks were formed are denoted as x, and specimens in which no crack was formed are denoted as O. Also, the broken line indicated in FIG. 11 is a straight line that satisfies the relationship that basis weight W (mg/cm²)/drying time T (sec.)=0.3.

As shown in FIG. 11, when the basis weight W of the positive electrode mixture paste 12 was controlled 5.85 mg/cm², no crack was formed even if the drying time for which the positive electrode mixture paste 12 was dried by the drying device 301 was 18 seconds. Namely, even if the relationship that basis weight W (mg/cm²)/drying time T (sec.)=5.85/18=0.325 0.3 was satisfied, no crack was formed in the coating film (electrode mixture layer) formed by drying the positive electrode mixture paste 12.

However, in the case where the basis weight W of the positive electrode mixture paste 12 was increased to 12.5 mg/cm², cracks were formed when the drying time for which the positive electrode mixture paste 12 was dried by the drying device 301 was 38.5 seconds. Namely, when the basis weight W of the positive electrode mixture paste 12 was controlled to 12.5 mg/cm², and the positive electrode mixture paste 12 was dried while satisfying the relationship that basis weight W (mg/cm²)/drying time T (sec.)=12.5/38.5=0.325≧0.3, cracks were formed in the coating film (electrode mixture layer) formed by drying the positive electrode mixture paste 12. Then, as the drying time was gradually increased, the drying time for which the positive electrode mixture paste 12 can be dried without causing cracks to be formed was determined. As a result, it was found that the positive electrode mixture paste 12 can be dried without causing cracks to be formed, if it is dried over a long period of time, with the drying time set to 180 seconds or longer.

In the case where the basis weight W of the positive electrode mixture paste 12 was increased to 20 mg/cm², cracks were formed when the drying time for which the positive electrode mixture paste 12 was dried by the drying device 301 was 61.5 seconds. Namely, when the basis weight W of the positive electrode mixture paste 12 was controlled to 20 mg/cm², and the positive electrode mixture paste 12 was dried while satisfying the relationship that basis weight W (mg/cm²)/drying time T (sec.)=20/61.5=0.325≧0.3, cracks were formed in the coating film (electrode mixture layer) formed by drying the positive electrode mixture paste 12. Then, as the drying time was gradually increased, the drying time for which the positive electrode mixture paste 12 can be dried without causing cracks to be formed was determined. As a result, it was found that the positive electrode mixture paste 12 can be dried without causing cracks to be formed, if it is dried over a long period of time, with the drying time set to 450 seconds or longer.

On the other hand, when the above-described drying test was conducted using the drying device 1 of the illustrated embodiment, no crack was formed when the basis weight W of the positive electrode mixture paste 12 was controlled to 5.85 mg/cm², and the drying time for which the positive electrode mixture paste 12 was dried was 18 seconds. Namely, even if the relationship that basis weight W (mg/cm²)/drying time T (sec.)=5.85/18=0.325≧0.3 was satisfied, no crack was formed in the coating film (electrode mixture layer) of the positive electrode mixture paste 12.

In the drying test using the drying device 1 of the illustrated embodiment, no crack was formed when the basis weight W of the positive electrode mixture paste 12 was increased to 12.5 mg/cm², and the drying time for which the positive electrode mixture paste 12 was dried was 38.5 seconds. Namely, where the basis weight W of the positive electrode mixture paste 12 was controlled to 12.5 mg/cm², no crack was formed in the coating film (electrode mixture layer) formed by drying the positive electrode mixture paste 12, even when the positive electrode mixture paste 12 was dried while satisfying the relationship that basis weight W (mg/cm²)/drying time T (sec.)=12.5/38.5=0.325≧0.3.

In the drying test using the drying device 1 of the embodiment, no crack was formed when the basis weight W of the positive electrode mixture paste 12 was increased to 20 mg/cm², and the drying time for which the positive electrode mixture paste 12 was dried was 61.5 seconds. Namely, where the basis weight W of the positive electrode mixture paste 12 was controlled to 20 mg/cm², no crack was formed in the coating film (electrode mixture layer) formed by drying the positive electrode mixture paste 12, even when the positive electrode mixture paste 12 was dried while satisfying the relationship that basis weight W(mg/cm²)/drying time T (sec.)=20/61.5=0.325≧0.3.

It will be understood from the above results that, when the basis weight W of the positive electrode mixture paste deposited on the first surface of the positive electrode current collector is controlled to be equal to or larger than 10 mg/cm², and the electrode mixture paste is dried by exposing the upper surface of the first paste-coated member (formed by coating the first surface of the electrode current collector with the electrode mixture paste) to hot air fed from the upper fans, and exposing the lower surface of the first paste-coated member to hot air fed from the lower fans, while controlling the temperature and quantity of hot air fed from the upper fans and the lower fans to equal values, cracks are likely to be formed in the electrode mixture layer formed by drying the electrode mixture paste. In particular, when the electrode mixture paste is dried with the drying time of the electrode mixture paste being set to a period of time that satisfies the relationship that “basis weight W (mg/cm²)/drying time T (sec.)≧0.3”, cracks are likely to be formed.

On the other hand, in the case where the basis weight W of the positive electrode mixture paste deposited on the first surface of the positive electrode current collector is controlled to be equal to or larger than 10 mg/cm², if the positive electrode mixture paste 12 is dried such that the quantity of heat applied to the lower surface of the first paste-coated member 10B is made larger than the quantity of heat applied to the upper surface of the first paste-coated member 10B, cracks are prevented from being formed or less likely to be formed in the electrode mixture layer 13 formed by drying the positive electrode mixture paste 12. Namely, in the initial stage of drying, the positive electrode mixture paste 12 is dried such that the quantity of heat applied to the second surface 11c of the positive electrode current collector 11 on which the positive electrode mixture paste 12 is not deposited is made larger than the quantity of heat applied to the surface 12b of the positive electrode mixture paste 12 deposited on the first surface 11b of the positive electrode current collector 11, so that cracks are prevented from being formed or less likely to be formed in the electrode mixture layer 13. This method is particularly useful when the electrode mixture paste is dried with the drying time of the positive electrode mixture paste being set to a period of time that satisfies the relationship that “basis weight W (mg/cm²)/drying time T (sec.)≧0.3”.

Similar results were obtained when the above-described drying test was applied to the second drying step. Namely, similar results were obtained when the above-described drying test was conducted on each second paste-coated member formed by coating the second surface 11c of the positive electrode current collector 11 with the positive electrode mixture paste 12, after coating the first surface 11b of the positive electrode current collector 11 with the positive electrode mixture paste 12 and drying the positive electrode mixture paste 12.

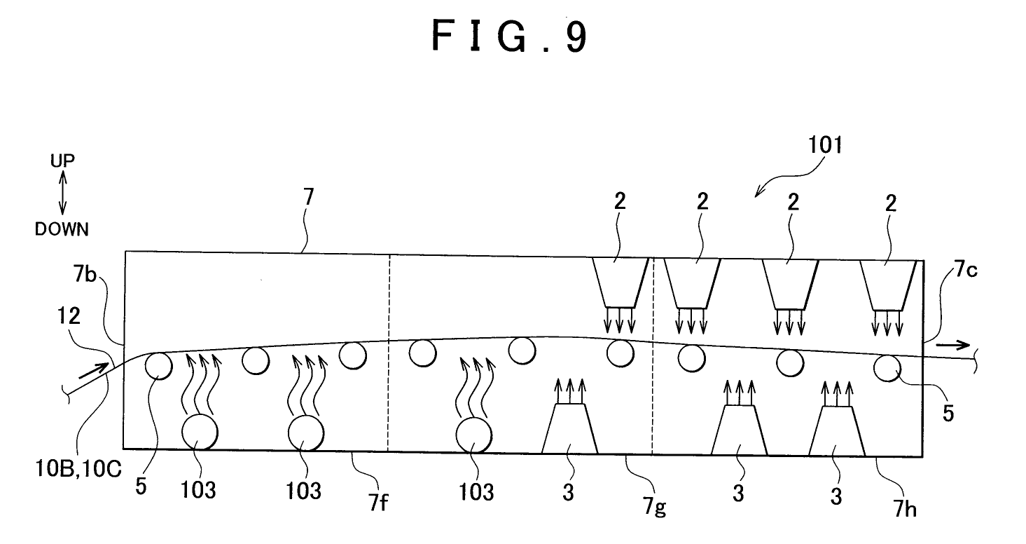

Next, a modified example of the illustrated embodiment of the invention will be described. As shown in FIG. 9, a drying device 101 of the modified example is different from the drying device 1 of the illustrated embodiment in that the two lower fans 3 disposed in the first zone 7f and one of the lower fans 3 disposed in the second zone 7g and located closer to the inlet 7b are replaced with infrared heaters 103. With the drying device 101 of the modified example, the lower surface of the first paste-coated member 10B formed by coating the first surface 11b of the positive electrode current collector 11 with the positive electrode mixture paste 12, i.e., the second surface 11c of the positive electrode current collector 11, are irradiated with infrared rays applied from the infrared heaters 103, in the initial stage of the first drying step. Also, in the initial stage of the second drying step, the lower surface of the second paste-coated member 10C formed by coating the second surface 11c of the positive electrode current collector 11 with the positive electrode mixture paste 12, i.e., the surface 13b of the electrode mixture layer 13 formed on the first surface 11b, is irradiated with infrared rays applied from the infrared heaters 103.

In the modified example, in the initial stage of the first drying step, the first paste-coated member 10B formed by coating the first surface 11b of the positive electrode current collector 11 with the positive electrode mixture paste 12 is not irradiated at the upper surface (i.e., the surface 12b of the positive electrode mixture paste 12) with infrared rays (or not exposed to hot air), but is irradiated at the lower surface (i.e., the second surface 11c of the positive electrode current collector 11) with infrared rays applied from below the first paste-coated member 10B so as to be heated. Further, in the initial stage of the second drying step, the second paste-coated member 10C formed by coating the second surface 11c of the positive electrode current collector 11 with the positive electrode mixture paste 12 is not irradiated at the upper surface (i.e., the surface 12b of the positive electrode mixture paste 12) with infrared rays (or not exposed to hot air), but is irradiated at the lower surface (i.e., the surface 13b of the electrode mixture layer 13) with infrared rays applied from below the second paste-coated member 10C so as to be heated.

Thus, in the modified example, too, in the initial stage of the first drying step, the positive electrode mixture paste 12 can be dried such that the quantity of heat applied to the lower surface of the first paste-coated member 10B formed by coating the first surface 11b of the positive electrode current collector 11 with the positive electrode mixture paste 12 is made larger than the quantity of heat applied to the upper surface of the first paste-coated member 10B, as in the illustrated embodiment. Namely, in the initial stage of drying of the positive electrode mixture paste 12 deposited on the first surface 11b, the positive electrode mixture paste 12 can be dried such that the quantity of heat applied to the second surface 11c on which the positive electrode mixture paste 12 is not deposited is made larger than the quantity of heat applied to the surface 12b of the positive electrode mixture paste 12 deposited on the first surface 11b. Thus, an inner portion (adjacent to the positive electrode current collector 11) of the positive electrode mixture paste 12 deposited on the first surface 11b can be dried earlier, or in a short time. Consequently, cracks are prevented from being formed or less likely to be formed in the electrode mixture layer 13 formed by drying the positive electrode mixture paste 12. Similarly, in the second drying step, cracks are prevented from being formed or less likely to be formed in the electrode mixture layer 13 formed on the second surface 11c of the positive electrode current collector 11.

While the invention has been described with reference to one embodiment and its modified example, it is to be understood that the invention is not limited to the illustrated embodiment and example, but may be embodied with changes as needed, without departing from the principle of the invention.

In the illustrated embodiment and example, the present invention is applied to the method for manufacturing positive electrodes. However, the invention may also be applied to a method for manufacturing negative electrodes.

The operation and effects provided by the manufacturing method of the illustrated embodiment of the invention will be described. In general, batteries used as power supplies for driving electric vehicles or hybrid vehicles are required to increase in capacity. In view of this requirement, in the manufacturing method of the illustrated embodiment of the invention, the basis weight of the electrode mixture paste deposited on the first surface in the first coating step is controlled to be equal to or larger than 10 mg/cm². With the basis weight of the electrode mixture paste thus controlled to be 10 mg/cm² or larger, the capacity of the resulting battery can be increased.

In the manufacturing method of the illustrated embodiment of the invention, in the first drying step, the drying time of the electrode mixture paste is set to a period of time that satisfies the relationship that “basis weight (mg/cm²)/drying time (sec.)≧0.3”. For example, the electrode mixture paste deposited on the electrode current collector such that the basis weight is 20 mg/cm² may be dried within 66.7 seconds (the drying time is made equal to or shorter than 66.7 seconds). With the drying time thus reduced, it is possible to increase the production efficiency of electrodes while achieving a large basis weight of the electrode mixture paste. When the drying time of the electrode mixture paste is set to a period of time that satisfies the relationship that “basis weight (mg/cm²)/drying time (sec.)≧0.3”, the drying temperature is preferably increased (to 150° C. or higher, for example), so that the electrode mixture paste is appropriately dried.

The case where the basis weight of the electrode mixture paste is as large as 10 mg/cm² or larger, and the electrode mixture paste is dried such that the temperature and quantity of hot air supplied from the first heater fan are equal to the temperature and quantity of hot air supplied from the second heater fan, as in JP 2000-106175 A, will be described. When the electrode mixture paste is dried by exposing the first paste-coated member (formed by coating the first surface of the electrode current collector with the electrode mixture paste) to hot air fed from the first heater fan disposed on one side of the first paste-coated member facing the electrode mixture paste, and also exposing the first paste-coated member to hot air fed from the second heater fan disposed on the other side of the first paste-coated member, cracks are likely to be formed. Furthermore, if the electrode mixture paste is dried at a high temperature in a short time, more specifically, if the electrode mixture paste is dried for a period of time that satisfies the relationship that “basis weight (mg/cm²)/drying time (sec.)≧0.3”, at a drying temperature around 150° C., cracks are more likely to be formed.

On the other hand, in the manufacturing method of the illustrated embodiment of the invention, in the initial stage of drying of the first drying step, the electrode mixture paste is dried such that the quantity of heat applied to the lower surface of the first paste-coated member (or the second surface of the electrode current collector) is made larger than the quantity of heat applied to the upper surface of the first paste-coated member provided by the exposed surface of the electrode mixture paste. As a result, cracks formed in the electrode mixture layer can be reduced or eliminated even if the basis weight and drying time are set as described above.

The electrode manufacturing method as described above may further include a second coating step of coating the second surface of the electrode current collector with the electrode mixture paste, after the first drying step, and a second drying step of drying the electrode mixture paste deposited on the second surface. In the initial stage of the second drying step, the electrode mixture paste is dried such that the quantity of heat applied to the lower surface of the second paste-coated member formed by coating the second surface of the electrode current collector with the electrode mixture paste (i.e., the surface of the electrode mixture layer formed on the first surface of the electrode current collector) is made larger than the quantity of heat applied to the upper surface of the second paste-coated member provided by the exposed surface of the electrode mixture paste.

In the manufacturing method of the illustrated embodiment of the invention, the electrode mixture paste is applied by coating to not only the first surface of the electrode current collector, but also the second surface, and then dried. More specifically, in the second coating step following the first drying step, the electrode mixture paste is applied by coating to the second surface of the electrode current collector. Then, in the second drying step, the electrode mixture paste deposited on the second surface is dried.

In the manufacturing method of the illustrated embodiment of the invention, in the initial stage of the second drying step, the electrode mixture paste is dried such that the quantity of heat applied to the lower surface of the second paste-coated member (formed by coating the second surface of the electrode current collector with the electrode mixture paste) is made larger than the quantity of heat applied to the upper surface of the second paste-coated member provided by the exposed surface of the electrode mixture paste. Namely, in the initial stage of drying of the electrode mixture paste deposited on the second surface, the electrode mixture paste is dried such that the quantity of heat applied to the surface of the electrode mixture layer formed on the first surface of the electrode current collector is made larger than the quantity of heat applied to the exposed surface of the electrode mixture paste deposited on the second surface of the electrode current collector. As a result, the inner portion (adjacent to the electrode current collector) of the electrode mixture paste deposited on the second surface can be dried in a shorter time, and, consequently, cracks are prevented from being formed or less likely to be formed in the electrode mixture layer. Accordingly, in the manufacturing method as described above, cracks are prevented from being formed or less likely to be formed in the electrode mixture layers formed by drying the electrode mixture paste deposited on the first surface and the second surface.

In the illustrated embodiment of the invention, in the initial stage of drying of the second drying step, the lower surface of the second paste-coated member, or the surface of the electrode mixture layer formed on the first surface of the electrode current collector, is exposed to hot air.

In the initial stage of drying, the second paste-coated member (formed by coating the second surface of the electrode current collector with the electrode mixture paste) is exposed to hot air fed from one side of the second paste-coated member which is closer to the first surface than to the second surface, but is not exposed to hot air fed from the other side of the second paste-coated member which is closer to the second surface than to the first surface, so that the electrode mixture paste can be dried such that the quantity of heat applied from the above-indicated one side of the second paste-coated member is made larger than the quantity of heat applied from the other side of the second paste-coated member. As a result, cracks are prevented from being formed or less likely to be formed in the electrode mixture layer formed by drying the electrode mixture paste deposited on the second surface.

In the above-described modified example of the embodiment of the invention, in the initial stage of the second drying step, the lower surface of the second paste-coated member, or the surface of the electrode mixture layer formed on the first surface of the electrode current collector, is irradiated with infrared rays.

In the initial stage of drying, the second paste-coated member (formed by coating the second surface of the electrode current collector with the electrode mixture paste) is irradiated with infrared rays applied from one side of the second paste-coated member which is closer to the first surface than to the second surface, but is not irradiated with infrared rays applied from the other side of the second paste-coated member which is closer to the second surface than to the first surface, so that the electrode mixture paste can be dried such that the quantity of heat applied from the above-indicated one side of the second paste-coated member is made larger than the quantity of heat applied from the other side of the second paste-coated member. As a result, cracks are prevented from being formed or less likely to be formed in the electrode mixture layer formed by drying the electrode mixture paste deposited on the second surface.

In the second coating step of the manufacturing method of the illustrated embodiment, the basis weight of the electrode mixture paste deposited on the second surface is controlled to be equal to or larger than 10 mg/cm². In the second drying step, the drying time of the electrode mixture paste is set to a period of time that satisfies the relationship that “basis weight (mg/cm²)/drying time (sec.)≧0.3”.

By controlling the basis weight of the electrode mixture paste deposited on the second surface to be as large as 10 mg/cm² or larger, the capacity of the resulting battery can be increased. Also, the production efficiency of electrodes can be enhanced by setting the drying time of the electrode mixture paste to a period of time that satisfies the relationship that “basis weight (mg/cm²)/drying time (sec.)≧0.3”.

Furthermore, in the manufacturing method of the illustrated embodiment of the invention, in the initial step of the second drying step, the electrode mixture paste is dried such that the quantity of heat applied to one surface of the second paste-coated member formed by coating the second surface of the electrode current collector with the electrode mixture paste, which surface is closer to the first surface than to the second surface, is made larger than the quantity of heat applied to the other surface of the second paste-coated member which is closer to the second surface than to the first surface. As a result, even if the basis weight and the drying time are set as described above, cracks are prevented from being formed or less likely to be formed in the electrode mixture layer formed by drying the electrode mixture paste.

What is claimed is:

1. A method for manufacturing electrodes, comprising:
applying an electrode mixture paste by coating to a first surface of an electrode current collector having the first surface and a second surface, to provide a first paste-coated member in which the electrode mixture paste is deposited on the first surface of the electrode current collector, the first paste-coated member having a first surface comprising a surface of the electrode mixture paste, and a second surface opposite to the first surface of the first paste-coated member; and
drying the electrode mixture paste deposited on the first surface of the electrode current collector, wherein
in an initial stage of drying of the electrode mixture paste, the electrode mixture paste is dried such that a quantity of heat applied to the second surface of the first paste-coated member is made larger than a quantity of heat applied to the first surface of the first paste-coated member.

2. The method according to claim 1, wherein
in the initial stage of drying, the second surface of the first paste-coated member is exposed to hot air.

3. The method according to claim 1, wherein
in the initial stage of drying, the second surface of the first paste-coated member is irradiated with infrared rays.

4. The method according to claim 1, wherein
a basis weight of the electrode mixture paste deposited on the first surface of the electrode current collector is controlled to be equal to or larger than 10 mg/cm², and a drying time for which the electrode mixture paste is dried is set to a period of time that satisfies a relationship that the basis weight (mg/cm²)/the drying time (sec.)≧0.3.

5. The method according to claim 1, further comprising:
applying the electrode mixture paste by coating to the second surface of the electrode current collector, after the electrode mixture paste deposited on the first surface is dried, to provide a second paste-coated member in which the electrode mixture paste is deposited on the second surface of the electrode current collector, the second paste-coated member having a first surface comprising a surface of the electrode mixture paste, and a second surface opposite to the first surface of the second paste-coated member; and
drying the electrode mixture paste deposited on the second surface of the electrode current collector, wherein
in an initial stage of drying of the electrode mixture paste deposited on the second surface of the electrode current collector, a quantity of heat applied to the second surface of the second paste-coated member is made larger than a quantity of heat applied to the first surface of the second paste-coated member.

6. The method according to claim 5, wherein
in the initial stage of drying of the electrode mixture paste deposited on the second surface of the electrode current collector, the second surface of the second paste-coated member is exposed to hot air.

7. The method according to claim 5, wherein
in the initial stage of drying of the electrode mixture paste deposited on the second surface of the electrode current collector, the second surface of the second paste-coated member is irradiated with infrared rays.

8. The method according to claim 5, wherein
a basis weight of the electrode mixture paste deposited on the second surface of the electrode current collector is controlled to be equal to or larger than 10 mg/cm², and a drying time for which the electrode mixture paste deposited on the second surface of the electrode current collector is dried is set to a period of time that satisfies a relationship that the basis weight (mg/cm²)/the drying time (sec.)≧0.3.

9. The method according to claim 1, wherein
in the initial stage of drying of the electrode mixture paste, a quantity of heat applied from one side of the first paste-coated member which is closer to the second surface of the electrode current collector than to the first surface thereof is made larger than a quantity of heat applied from the other side of the first paste-coated member which is closer to the first surface than to the second surface.

10. The method according to claim 9, wherein
in the initial stage of drying of the electrode mixture paste, hot air is fed from said one side of the first paste-coated member, while no hot air is fed from the other side of the first paste-coated member.
